(19) United States
(12) Patent Application Publication
(10) Pub. No.: US 2024/0383665 A1
(43) Pub. Date: Nov. 21, 2024

(54) INSULATING CONTAINER

(71) Applicant: RTIC Outdoors LLC, Houston, TX (US)

(72) Inventors: Steve Whitworth, Houston, TX (US); David Findlay, Houston, TX (US)

(21) Appl. No.: 18/318,586

(22) Filed: May 16, 2023

(51) Int. Cl. B65D 81/38; B62B 1/12; B62B 5/06; B65D 25/28; B65D 43/16; B65D 45/22; B65D 51/28

(52) U.S. Cl. CPC B65D 81/3816; B62B 1/12; B62B 5/067; B65D 25/2852; B65D 43/165; B65D 45/22; B65D 51/28; B65D 81/3825; B62B 2204/06; B65D 2251/1058; B65D 2543/00194

(57) ABSTRACT

A container having a base that includes an outer wall, an internal insulation layer, and an inner wall. The container further including a movable lid connected to the base, a handle connected to the base, and a first wheel and a second wheel that are connected by an axle extending through the base. The container further includes a suspension system that is connected to the outer wall and includes at least one ball bearing in association with the first wheel and the second wheel.

### CROSS REFERENCE TO RELATED APPLICATIONS

None

### REFERENCE REGARDING FEDERALLY SPONSORED RESEARCH OR DEVELOPMENT

Not applicable

### SEQUENCE LISTING

Not applicable

### BACKGROUND OF THE DISCLOSURE

### 1. Field of the Disclosure

The present disclosure relates to non-rigid and rigid portable containers and methods of manufacturing and use therefore, including a container for use with beverage cans, which is also known as a cooler.

### 2. Description of the Background of the Disclosure

Containers for storage, thermal insulation, and protection of beverages or fluids are known as coolers. Coolers can be useful to transport, physically protect, and thermally insulate various items. For example, beverage containers, including aluminum cans or glass bottles for beer, seltzers, non-alcoholic beverages and the like, are often stored within a rigid or non-rigid portable cooler in large quantities and transported to a particular location for consumption. As a result, coolers that can receive large quantities of beverage containers and prevent damage of the beverage containers during transport are desired. Further, beverages are often enjoyed at cold temperatures and, thus, it is desired for coolers to thermally insulate the beverage containers during transport and/or during storage on-site. In addition, coolers with multiple compartments and dry storage may be desired to transport items or accessories, some of which may be used during enjoyment of cold beverages.

### SUMMARY

Various aspects are described in connection with illustrative implementation of a container disclosed herein. In some aspects, a container includes a base that includes an outer wall, an internal insulation layer, and an inner wall. The container may also include a movable lid connected to the base, a handle connected to the base, and a first wheel and a second wheel that are connected by an axle extending through the base. The container further includes a suspension system that is connected to the outer wall and include at least one ball bearing in association with the first wheel and the second wheel. In some embodiments, the container includes an axle that extends through an outer support structure and an inner support structure of the suspension system. In some embodiments, the inner support structure is a plate with a central aperture that is configured to allow the axle to extend through the plate. In some embodiments, the plate has a plurality of threaded apertures that are spaced radially about the central aperture and configured such that a plurality of screws can be used to mount the plate to the outer wall and the outer support structure to the plate.

In some embodiments, the outer wall has one or more support walls configured to support the plate on an inner side of the outer wall of a wheel well. In some embodiments, the outer support structure has a cylindrical wall and an angled surface that extends inwardly toward a first flat surface that has a central aperture configured to receive the axle. In some embodiments, the lid has a bottom surface facing an internal volume of the container, and the bottom surface of the lid has a rectangular protrusion with a cargo net attached thereto. In some embodiments, the lid is moveably connected to the base by a hinge. In some embodiments, the inner wall and the outer wall are made of injection molded plastic.

According to another aspect of the disclosure, a container includes a base that includes an outer wall, an internal insulation layer, and an inner wall. The container includes a movable lid connected to the base, a handle connected to the base, a first and a second wheel connected to the base through an axle and a suspension system. Further, the first and the second wheels include a central hub, an internal tire support structure, and a tire. In some embodiments, the central hub has one or more protruding screw receivers that are configured to connect the central hub to the internal tire support structure. In some embodiments, the internal tire support structure comprises first and second internal tire support structure halves that are interchangeable and independently attached to the central hub. In some embodiments, the internal tire support structure includes one or more protruding walls that protrude from an outer rounded surface. In some embodiments, each wheel uses one or more ball bearings that are restrained on the axle by a ring like clip in a groove on the axle. In some embodiments, the inner wall has a plurality of injection spacer walls that extend from a bottom surface of the inner wall that are configured to facilitate dispersion of insulation when manufacturing the internal insulation layer. In some embodiments, the plurality of injection spacer walls have at least one guide wall that extends from a right side to a left side and at least one injection spacer wall that extends from a front side to a rear side.

According to another aspect of the disclosure a container includes a base including an outer wall, an internal insulation layer, and an inner wall. The container also includes a movable lid connected to the base, a handle connected to the base, and a handle release system that is configured to apply friction on the handle when moved in at least one direction. In some embodiments, the handle release system comprises at least one dampener. In some embodiments, the dampener comprises silicone. In some embodiments when the handle is in the open position, a handle angle is defined between a handle support beam and a vertical plane that is perpendicular to a ground plane is between about 100 degrees and about 120 degrees. In some embodiments, the lid has a rectangular protrusion that extends from a bottom surface of the lid, and the rectangular protrusion at least partially defines a storage space with the bottom surface of the lid and a cargo net that is attached to the rectangular protrusion.

Various alternative implementations of the foregoing aspects are disclosed. The foregoing various aspects may be combined in any manner without limitation. The foregoing and other aspects and advantages of the disclosure will appear from the following description. In the description, reference is made to the accompanying drawings, which form a part hereof, and in which there is shown by way of illustration a preferred configuration of the disclosure. Such configuration does not necessarily represent the full scope of the disclosure, however, and reference is made therefore to the claims herein for interpreting the scope of the disclosure.

### BRIEF DESCRIPTION OF THE DRAWINGS

The present disclosure will be better understood and features, aspects, and advantages other than those set forth above will become apparent when consideration is given to the following detailed description thereof. Such detailed description makes reference to the following drawings.

FIG. 1 is a front, left, and top isometric view of a container, according to an embodiment of the present disclosure;

FIG. 2 is a rear, right, and top isometric view of the container of FIG. 1;

FIG. 3 is an exploded view of the base and lid of the cooler of FIG. 1;

FIG. 4 is a front, left, and top isometric view of the container of FIG. 1 showing the lid in an open configuration;

FIG. 5 is a left side elevational view of the container of FIG. 1 showing the lid in the open configuration;

FIG. 6 is a front elevational view of the container of FIG. 1;

FIG. 7 is a front elevational view of the container of FIG. 1 showing a handle in a raised configuration;

FIG. 8 is a left side elevational view of the container of FIG. 1 with an outer wall being shown as transparent;

FIG. 9 is an enlarged, partial view of FIG. 8;

FIG. 10 is a front, right, and top view of a portion of the container of FIG. 8;

FIG. 11 is a perspective view of an axle and a wheel of the container of FIG. 1;

FIG. 12 is a partial view of an interior section of the outer wall of the container of FIG. 1, in which a plug and components of an axle assembly are illustrated;

FIG. 13 is partial view of the interior section of the outer wall of FIG. 12 shown without the axle;

FIG. 14 is a partial view of an outer section of the outer wall of the container of FIG. 1, in which components of the axle assembly are illustrated;

FIG. 15 is a partial view of the outer section of FIG. 14 shown without the components of the axle assembly;

FIG. 16 is a partial, perspective view of the axle assembly, according to an embodiment of the present disclosure;

FIG. 17 is an exploded view of a wheel assembly, according to an embodiment of the present disclosure; and

FIG. 18 is a front, right, and bottom view of a base for a container, according to another embodiment of the present disclosure, the base having an outer wall being shown as transparent.

Before the embodiments of the disclosure are explained in detail, it is to be understood that the disclosure is not limited in its application to the details of construction and the arrangement of the components set forth in the following description or illustrated in the drawings. Aspects of the disclosure are capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE DRAWINGS

The features, aspects and advantages are described below with reference to the drawings, which are intended to illustrate but not to limit the present disclosure. Multiple embodiments are provided within the disclosure. In the drawings, like reference characters denote corresponding features consistently throughout the drawings. Also, while the terms “left side”, “right side,” “front side,” “back side,” “top,” “base,” “bottom,” “side,” “forward,”, “rear” and “rearward” and the like may be used in this specification to describe various example features and elements, these terms are used herein as a matter of convenience, e.g., based on the example orientations shown in the figures and/or the orientations in typical use. Unless otherwise stated, nothing in this specification should be construed as requiring a specific three dimensional or spatial orientation of structures in order to fall within the scope of the claims.

In the description that follows, reference is made to one or more container structures. It is contemplated that any of the disclosed structures may be constructed from any polymer, composite, plastic, injection molded plastic, and/or metal/alloy material, without departing from the scope of the disclosure. Additionally, it is contemplated that any manufacturing methodology may be utilized, without departing from the scope of the disclosure. For example, one or more of welding (e.g., high frequency, ultrasonic welding, or laser welding of fabric, or metal/alloy welding), gluing, stitching, molding, injection molding, blow molding, stamping, deep-drawing, casting, die-casting, rotational molding, or additive manufacturing processes may be used, as well as various finishing processes, including drilling, deburring, grinding, polishing, sanding, or etching processes, among many others, may be utilized to construct the various container structures, or portions thereof, described throughout the disclosure.

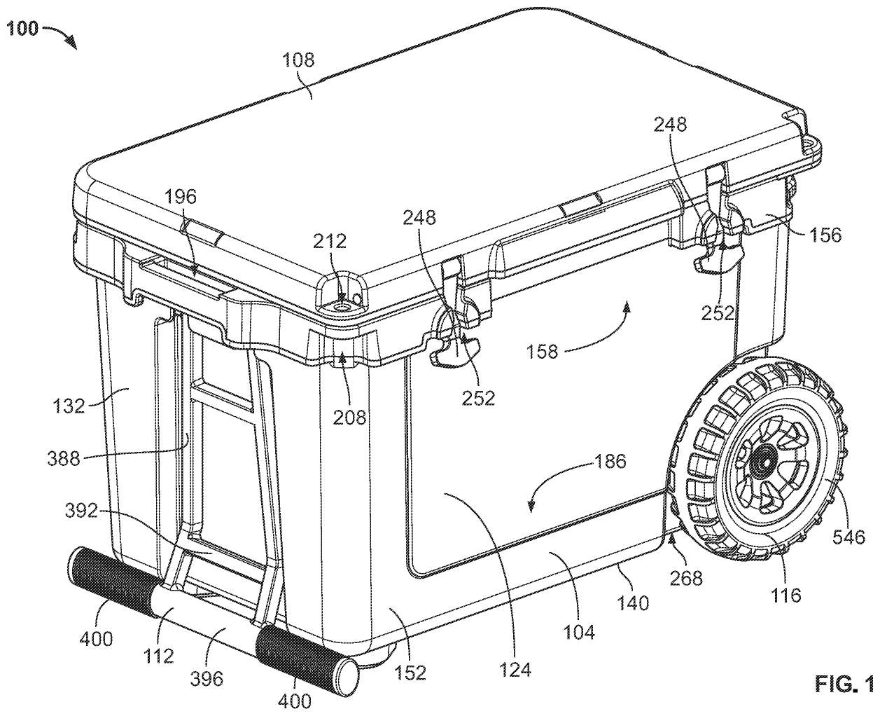

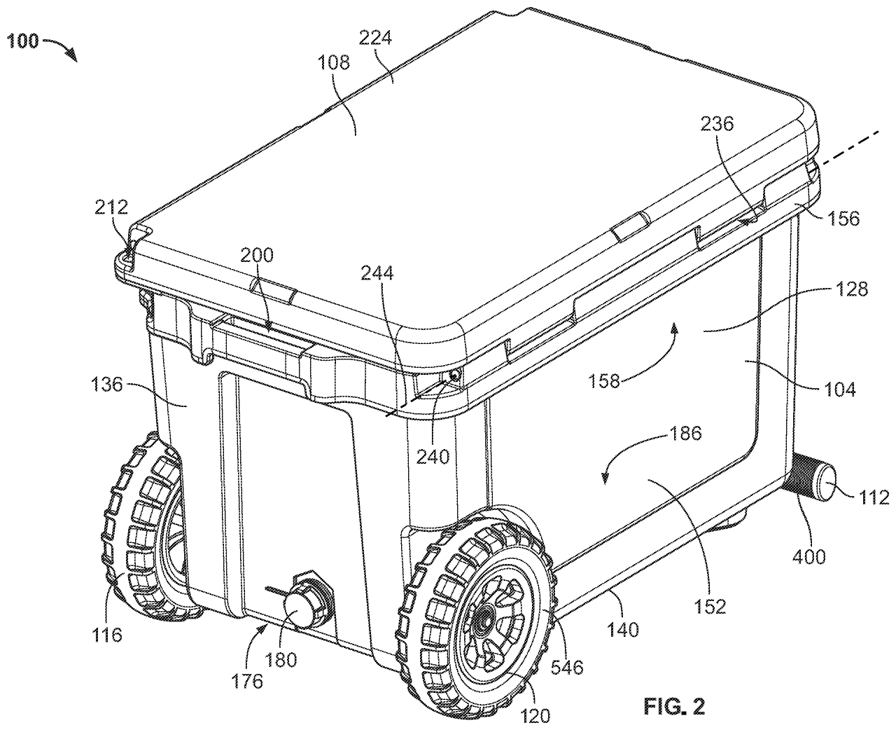

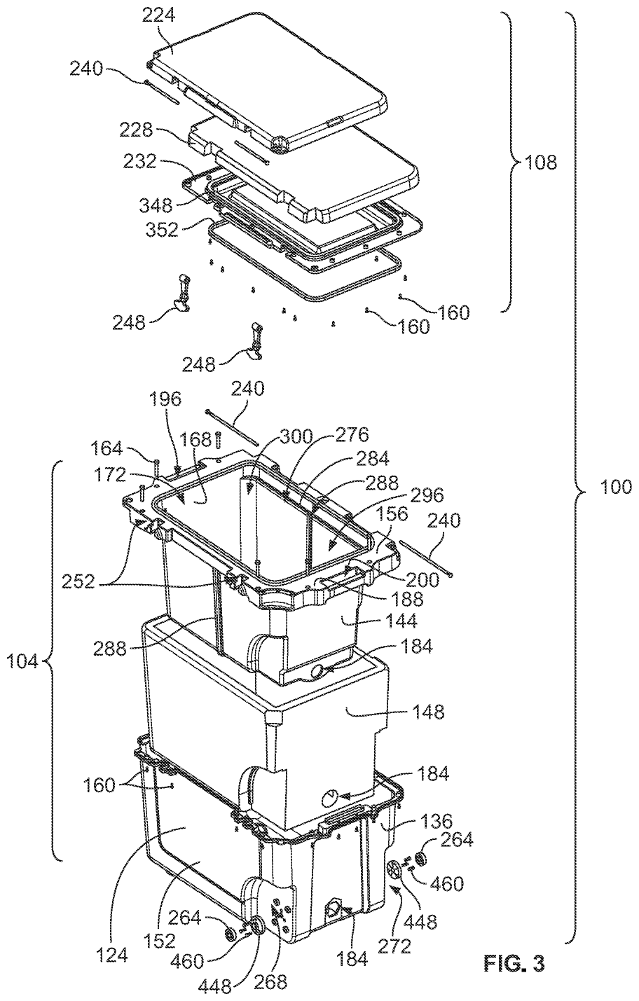

FIGS. 1 and 2 illustrate various aspects of a container 100, which may be configured as an insulating container, a cooler, or an insulative enclosure, according to a first aspect of the present disclosure. In some applications, the container 100 is configured for transport, protection, and thermal insulation of one or more beverage containers (not shown). It should be understood, however, that the teachings herein are not limited to any particular beverage container, and are applicable to enclosures for containers of other products, including solids and liquids of various forms, temperatures, and compositions. As illustrated in FIG. 1, the container 100 comprises a base 104, a lid 108, a handle 112, a first wheel 116, and a second wheel 120. The base 104 includes four side walls including a front wall 124, a rear wall 128, a left side wall 132, and a right side wall 136, each of which extend upwardly from a perimeter of a base bottom 140. The base 104 of the cooler is configured as a base assembly that includes a base inner wall 144, a base internal insulation layer 148, and a base outer wall 152, which are shown and described in relation to FIG. 3. A rim 156 extends about an upper section 158 of the base 104 along the front, rear, left, and right walls 124, 128, 132, 136. In the illustrated embodiment, the rim 156 is integral with the structure of the base inner wall 144 and provides a connection point between the base inner wall 144 and the base outer wall 152. The base inner wall 144 and the base outer wall 152 may be connected to each other along the rim 156 using one or more screws 160 and locking plugs 164 as shown, rivets, glue, or any other fastening mechanism or adhesive known in the art. In some embodiments, the base inner wall 144 and the base outer wall 152 may also be formed together as a unitary component, without fastening mechanisms or adhesives for attachment. The base inner wall 144 defines a base internal surface 168 that partially defines and faces an internal volume 172 of the container 100, which is shown in FIG. 3.

Referring to FIG. 2, the container 100 includes a drain assembly 176 that has a drain plug 180 that fits within a drain aperture 184 that extends through the base outer wall 152, the base internal insulation layer 148, and the base inner wall 144. As illustrated in FIG. 2, the drain assembly 176 is located on a lower section 186 of the right side wall 136. Accordingly, the drain assembly 176 is configured as a drain for passing the contents stored within the internal volume 172 to the surrounding environment. Thus, the drain assembly 176 includes a drain plug 180 that can be selectively opened, to allow contents to pass through, and closed, to prevent contents from passing through. Additionally, the drain assembly 176 is positioned on the right side wall 136 and adjacent to the base bottom 140 to facilitate drainage when a user lifts the container 100, such as with the handle 112, to tilt the container 100 and allow any fluids, such as water from melted ice, to flow out of the drain aperture 184.

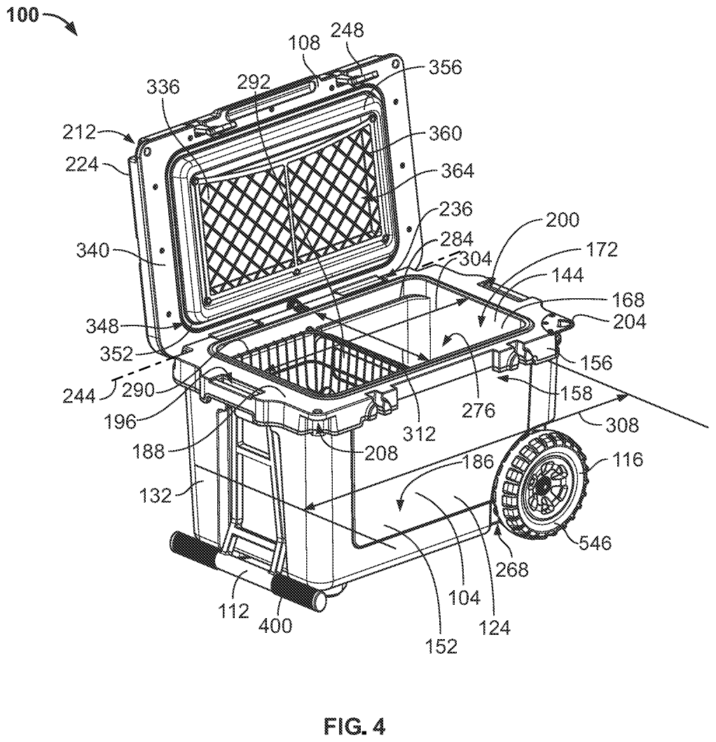

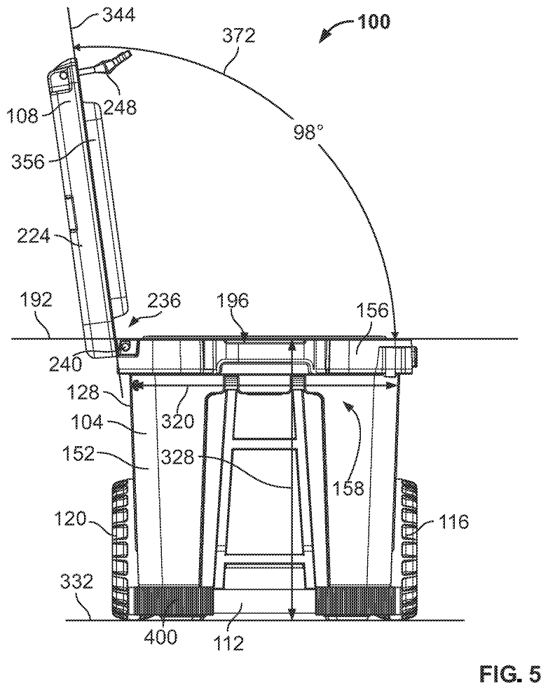

Still referring to FIGS. 1 and 2, the rim 156 has a rim top surface 188 that defines a base rim plane 192 (shown in FIGS. 3 and 5), and integrated within the rim 156 are a left integrated lift slot 196 and a right integrated lift slot 200 that are located above the left side wall 132 and right side wall 136, respectively. The integrated lift slots 196, 200 are sized and configured as handles so a user can insert their hands within the lift slots 196, 200 to move and lift the container 100 during transport. Further, the lift slots 196, 200 can be used as a tie down for the container 100, such as when the container 100 is on a boat deck (not shown) or in a truck bed (not shown). The rim 156 also has a bottle opener 204 (see FIG. 4) that is mounted or integrated on the rim 156 at the corner above the right side wall 136 and the front wall 124. In some embodiments, the bottle opener 204 is formed of metal and is secured to the rim 156. It is contemplated that the bottle opener 204 can be mounted in a different position on the container 100 and/or made of a different material.

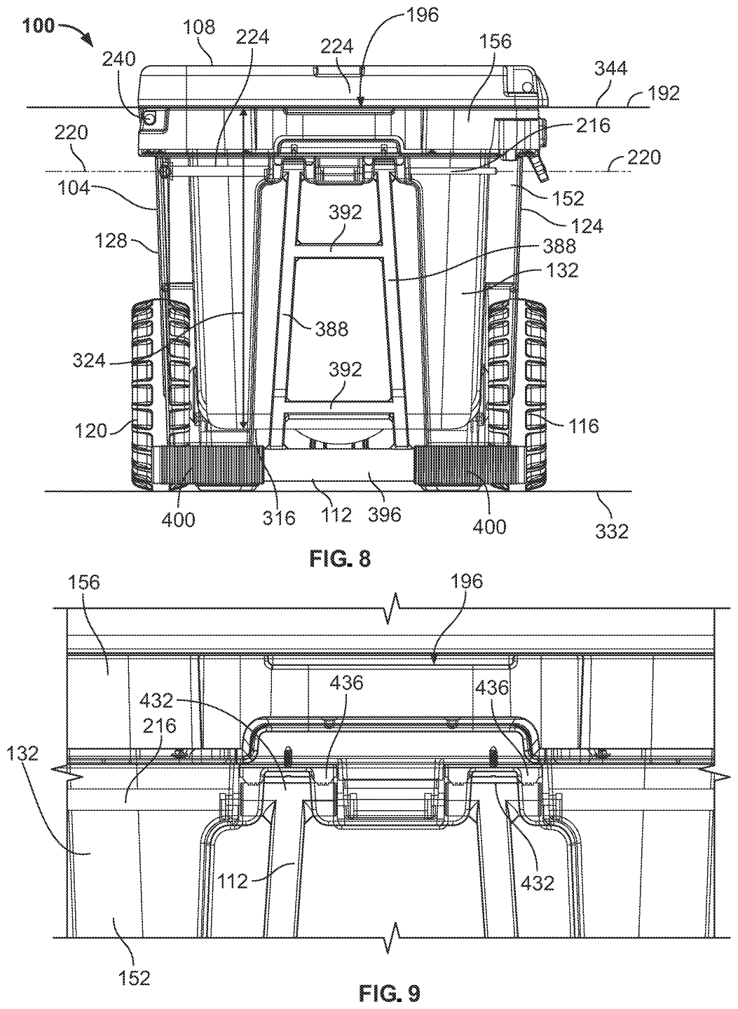

In some embodiments, the container 100 may not have a bottle opener. The rim 156 also includes a lower lock aperture 208 (shown in FIG. 4) that is part of the base 104 and corresponds with an upper lock aperture 212 that is part of the lid 108. In some embodiments there may be more than one set of lower and upper locking apertures 208, 212. In some embodiments, there may be no lower and upper locking apertures 208, 212. In some embodiments, a bottle opener such as the bottle opener 204 may function as a locking aperture. When the container 100 is in a lid closed configuration, the lower and the upper lock apertures 208, 212 are configured to be axially aligned for receiving a lock (not shown), e.g., a pad lock or a combination lock, through the lower and the upper lock apertures 208, 212 to secure the container 100 in a closed configuration. It is contemplated that the lower and upper lock apertures 208, 212 may be sized or shaped to receive a uniquely shaped locking mechanism, so as to provide a lock-and-key functionality. The lower and upper lock apertures 208, 212 may further be sized and shaped to promote a rope, strap, tether, chain, or other fastener to be passed or threaded through for attaching or securing the container 100 to an object or location. Continuing along the rim 156, the base 104 also includes a handle hinge 216 (shown in FIGS. 8 and 9) for the handle 112 within the rim 156 above the left side wall 132. The handle hinge 216 defines a handle hinge axis 220 about which the handle 112 can be rotated.

Still referring to FIGS. 1 and 2, the lid 108 includes a lid outer wall 224, a lid internal insulation layer 228, and a lid inner wall 232 that are discussed in more detail below and shown in FIG. 3. The lid 108 is movably connected to the base 104 by a lid hinge 236. In particular, the lid hinge 236 uses lid hinge pins 240 that are mounted within the rim 156 above the rear sidewall 128. The lid hinge pins 240 and hinge 236 define a lid hinge axis 244 that the lid 108 can be rotated about. The rotation of the lid 108 about the lid hinge axis 244 is discussed in more detail below. In some embodiments, the lid 108 is attached to the base 104 along a living hinge (not shown) without the use of lid hinge pins 236. Further, the lid 108 may be removably attached to the front wall 124 using latches 248 and latch restrainers 252 that function as a closure mechanism. The latches 248 may be provided in a shape resembling a “T” and made of silicon, rubber, or another durable, elastomeric or rubber-like material. In the illustrated embodiment, the latch restrainers 252 are integrally formed on the rim 156. In some embodiments, the container 100 may use a zipper, a rail-type closure mechanism, a hook and loop fastener, a tab, an interference fitting closure mechanism, an interlocking closure mechanism, a magnetic closure mechanism, or any other suitable type of fastener, without departing from the scope of these disclosures.

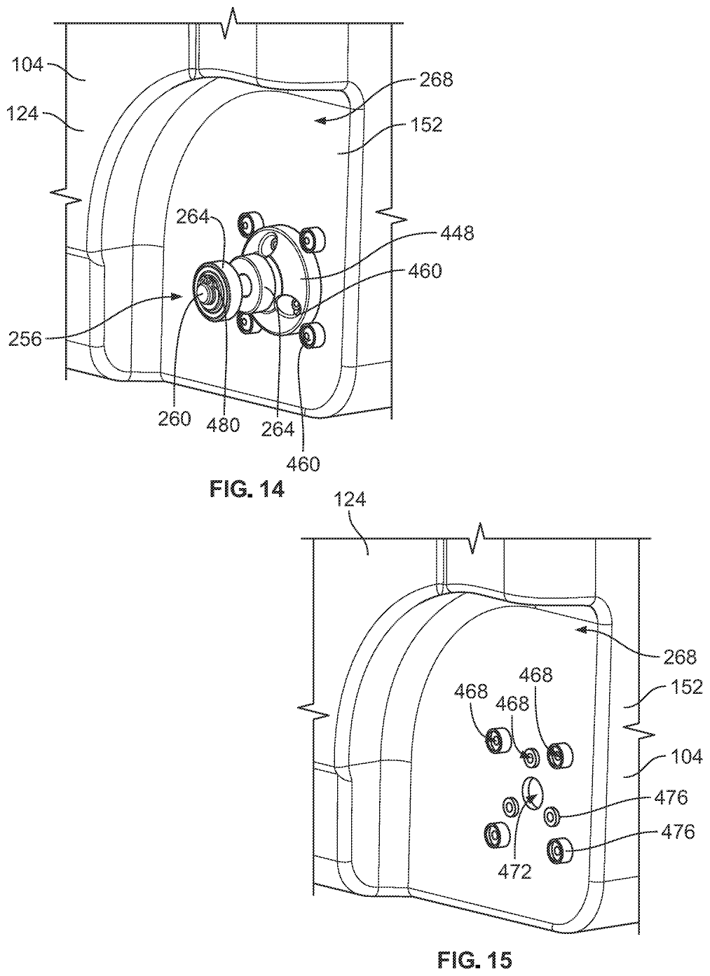

Still referring to FIGS. 1 and 2, the container 100 has a first wheel 116 and a second wheel 120 that are mounted on a suspension system 256 that includes an axle 260 and ball bearings 264, as shown in FIGS. 11 and 14 and described below. The wheels 116, 120 are configured to be positioned in a front wheel well 268 and a rear wheel well 272, respectively, such that the wheels 116, 120 are not positioned entirely outside of a profile of the base 104. Put another way, the front wheel well 268 and the rear wheel well 272 are recessed inwardly toward one another to provide a recess for positioning an innermost end of the wheels 116, 120 within the recess and inwardly of the outer wall 152.

Now referring to FIG. 3, an exploded view of the base 104 and the lid 108 are shown without the wheels 116, 120 and the suspension system 256. As mentioned above, the base 104 and the lid 108 each include three layers. In particular, the base 104 includes the outer wall 152, the internal insulation layer 148, and the inner wall 144. In a similar fashion, the lid 108 includes the lid outer wall 224, the lid internal insulation layers 228, and the lid inner wall 232. The outer walls 152, 224 and the inner walls 144, 232 for both the base 104 and the lid 108 may be constructed from injection molded plastic, such as, e.g., polypropylene (“PP”), homopolymer PP, Copolymer PP, Random Copolymer, thermoplastics, and/or any other plastics or polyolefins, or combinations thereof. In some embodiments, the base 104 and/or the lid 108 may be formed of one or more materials that are ultraviolet (UV) resistant and food grade. The internal insulation layers 148, 228 for both the base 104 and the lid 108 may be made of polyurethane, open-cell or closed-cell foam, or any other known insulative material. The internal insulation layers 148, 228 may be provided as closed-cell foam insulation of about 2.5 inches in thickness to enable the container 100 for ice retention over extended periods of time, such as, e.g., about 7 hours or more. The internal insulation layers 148, 228 can be injected between the inner walls 144, 232 and outer walls 152, 224 during the manufacturing of the container 100, although other configurations are possible. In some embodiments, the insulation layers 148, 228 are placed between the inner walls 144, 232 and outer walls 152, 224 during the manufacturing process.

Still referring to FIG. 3, the base inner wall 144, the base internal insulation layer 148, and the base outer wall 152 all have corresponding shapes that are a generally rectangular with a top opening 276 that is rectangular and opens to the internal volume 172 of the base 104. Further, the front and the rear wheel wells 268, 272 are accommodated by corresponding recessed portions of the base inner wall 144, the base internal insulation layer 148, and the base outer wall 152. As shown, the base inner wall 144 is configured and sized such that it can be nested into the base outer wall 152 with a void between the base inner wall 144 and the base outer wall 152. The void is configured such that an insulative material can be injected into the void to form the base internal insulation layer 148. As shown in FIGS. 3 and 4, the inner wall 144 has an internal rim 284 that extends along the upper portion of the front and rear sidewalls 124, 128, such that the internal rim 284 is configured to hold a basket 290 (Shown in FIG. 4) that can be supported by the internal rim 284 and extend above the base bottom 140.

Additionally, the base inner wall 144 has vertical grooves 288 on the front and rear walls 124, 128 that are configured to receive a cold pack or divider 292, which may or may not contain a medium for maintaining low temperatures over extended periods of time (e.g., an hour or more). In some instances, the cold pack 292 can be used to separate the main compartment into a right side 296 and a left side 300. In some embodiments, the cold pack 292 may create a watertight seal with the container 100 to, for example, separate dry storage on the left side 300 and wet storage with ice on the right side 296, or vice versa. It will be appreciated that container 100 and cold pack 292 can be positioned centrally in the internal volume 172, such that the left side 300 and the right side 296 define equal volumes. In some embodiments, the container 100 and cold pack 292 are offset to form the left side 300 and the right side 296 of different volumes from one another.

Now referring to FIGS. 4 and 5, the container 100 is shown with the lid 108 in an open configuration with the internal volume 172 of the base 104 being at least partially exposed. The container 100 has an internal width 304 between the upper portion of the base inner wall 144 corresponding with the right side wall 136 and the upper portion of the base inner wall 144 corresponding with the left side wall 132 that is between about 18 inches and about 24 inches, or about 21 inches. In some embodiments, the internal width 304 is between about 16 inches and about 22 inches, or about 19.5 inches. The container 100 has an external width 308 that is measured from the upper portion of the base outer wall 152 corresponding with the right side wall 136 to the upper portion of the base outer wall 152 corresponding with the left side wall 132. The external width 308 of the container 100 is between about 18 and 24 inches, or about 21 inches. In some embodiments, the external width 308 is between about 26 inches and about 32 inches, or about 29 inches. The container 100 has an internal depth 312 between the upper portion of the inner wall 144 corresponding with the front wall 124 and the upper portion of the inner wall 144 corresponding with the rear wall 128. The internal depth 312 of the container 100 is between about 11 and 17 inches, or about 14 inches. In some embodiments, the internal depth 312 is between about 8 inches and about 14 inches, or about 11 inches. The container 100 also has an external depth 320 that is measured from the upper portion of the outer wall 152 corresponding with the front wall 124 to the upper portion of the outer wall 152 corresponding with the rear wall 128. The external depth 320 of the container 100 is between about 13 and 19 inches, or about 13 inches. In some embodiments, the external depth 320 is between about 15 inches and about 21 inches, or about 18.25 inches.

Further, the container 100 has an internal base height 324 measured from an inner base bottom 316 to base rim plane 192 (Shown in FIG. 8). The internal base height 324 of the container 100 is about between 11 and 17 inches, or about 14 inches. In some embodiments, the internal base height between about 11 inches and about 17 inches, or about 14.125 inches. Additionally, the container 100 has an external base height 328 measured from the ground plane 332 to base rim plane 192. The external base height 328 of the container 100 is between about 13 and 19 inches. In some embodiments, the external base height 328 is about 16 inches. In some embodiments, the external base height 328 is between about 15 inches and about 21 inches, or about 18.75 inches. However, it is within the scope of this disclosure for each of the internal and external depths 312, 320, widths 304, 308, and heights 324, 328 to be substantially equal, thereby forming a generally square-shaped container.

Due to the internal width 304, internal depth 312, and internal height 324, the container 100 has an internal volume 172 of between about 2,200 and 6,900 cubic inches. In some embodiments, the container 100 has an internal volume 172 of about 4,150 cubic inches such that the container 100 can carry about ninety-six (96) beverage cans (e.g., 12 ounce cans), about seventy-two (72) water bottles (e.g., 16 ounce bottles), or about seventy-five (75) pounds of ice. In some examples, the internal volume 172 includes the internal width 304, the internal depth 312, and the internal height 324, such that a particular quantity of beverage containers of a standard size are configured to be received in a vertical position and arranged in a grid-like fashion, i.e., m x n. For example, the internal volume 172 may be configured to receive sixteen beverage containers arranged in a four-by-four grid, or thirty-two beverage containers in an eight-by-four grid. However, different quantities of beverage containers may be received within the internal volume 172 and may be arranged differently, such as, e.g., stacked vertically atop one another and/or disposed in horizontal positions below the rim 156 atop of each of the walls 124, 128, 132, 136 such that the lid 108 can be rotated about the hinge 236 to a closed configuration. In some embodiments, the container 100 has an internal volume 172 of about 3,030 cubic inches, such that the container 100 can carry about seventy-eight (78) beverage cans (e.g., 12 ounce cans) or about fifty-three (53) pounds of ice.

Referring to FIG. 4, the lid inner wall 232 has a lid bottom surface 336 that abuts the internal volume 172 of the base 104 when the lid 108 is in a closed configuration. The lid bottom surface 336 has a lid rim surface 340 that is a flat surface that extends around the peripheral of the lid 108. The lid rim surface 340 defines a lid rim plane 344 (shown in FIG. 5). Further, the lid rim surface 340 is configured such that when the lid 108 is in a closed configuration the lid rim surface 340 abuts the base rim top surface 188. Just within the lid rim surface 340 there is a sealing groove 348 that holds a gasket 352 that extends around inner peripheral of the lid rim surface 340. The gasket 352 is configured to create a generally water- and air-tight seal between the lid 108 and the base 104 when the lid 108 is in a closed configuration and the latches 248 are secured. The seal helps prevent the container 100 from leaking any fluids from within and allows for a slower rate of heat transfer between the internal volume 172 and a surrounding environment of the container 100. In some examples, the lid 108 is configured to provide an air-tight and water-tight seal between the ambient environment and the internal volume 172, such that the container 100 is configured to be water-resistant and/or waterproof. In some examples, the seal may not be completely air-tight or water-tight. Inside of the gasket 352, a raised rectangular protrusion 356 protrudes from the lid rim surface 340.

As shown in FIG. 3, the protrusion 356 is formed as part of the lid inner wall 232. In some embodiments, the protrusion 356 may be a separate component from the lid inner wall 232. As previously described, the rectangular protrusion 356 extends from the lid rim surface 340 to protrude into the internal volume 172 and to fit within the top opening 276 of the base 104. As such, the rectangular protrusion 356 has sloped or angled walls that provide a tapered shape, which acts as an alignment feature to ensure the lid 108 is properly aligned when rotated into the closed configuration. Further, the rectangular protrusion 356 prevents the lid 108 from movement laterally or horizontally when in the closed configuration, as another means of establishing durability and resilience against unintended detachment. Additionally, the rectangular protrusion 356 affords sufficient distance between the lid outer wall 224 and the lid inner wall 232 for arranging the lid internal insulation layer 228 to have adequate thickness and volume for slowing the rate of heat transfer between the internal volume 172 and the environment.

Further, the rectangular protrusion 356 can be configured to have a cargo net 360 secured thereto to provide a dry storage volume 364, i.e., a storage space or a storage compartment, that is accessible when the lid 108 is in the open configuration and enclosed when the lid 108 is in the closed configuration. In some embodiments, the cargo net 360 can be made of an elastomeric material, such as, e.g., silicone. In some embodiments, the cargo net 360 can be made of other plastic materials, synthetic materials, or natural materials. The cargo net 360 can be formed of fabric, such as segments of ropes or cables. The dry storage volume 364 is bounded by the rectangular protrusion 356, the lid bottom surface 336, and the cargo net 360. In the illustrated embodiment, the cargo net 360 spans across almost the entire the rectangular protrusion 356 and dry storage volume 364, such that the dry storage volume 364 is accessible by dislocating or pulling the cargo net 360 away from the bottom surface 336. Due to the location of the dry storage volume 364 along the lid bottom surface 336, the dry storage volume 364 is suspended above the internal volume 172 and, thus, is configured to stay dry when there is ice, water, and cold beverages stored in the internal volume 172 of the base 104. Despite being referred to as “the dry storage volume”, the dry storage volume 364 is not limited to any particular contents or ambient conditions. Further, the dry storage volume 364 may allow an exchange of various fluids into the dry storage volume 364, such as when the container 100 is rotated or dislocated from the upright position.

As shown in FIGS. 4 and 5, the lid hinge 236 defines a hinge axis 244 therethrough and the lid 108 is configured to be rotated about the hinge axis 244 between the closed configuration and the open configuration. When the lid 108 is in a fully open configuration as shown in FIG. 5, the lid rim plane 344 and the base rim plane 192 define a lid opening angle 372 that is about 98 degrees. In some embodiments, the angle may be greater than about 98 degrees, or greater than about 100 degrees, or greater than about 110 degrees or greater than about 130 degrees, or greater than about 150 degrees or greater than about 170 degrees or greater than about 180 degrees or greater than about 200 degrees or greater than about 220 degrees or greater than about 250 degrees or greater than about 265 degrees or about 270 degrees. In further embodiments, the lid opening angle 372 may be less than about 98 degrees or less than about 95 degrees or less than about 92 degrees or about 90 degrees. In the illustrated embodiment shown in FIG. 5, the lid 108 is shown to be in a fully open configuration with the lid opening angle 372 being about a 98 degree angle such that the lid 108 is configured to stay open when a user opens the lid 108 without the lid 108 rotating to the closed position due to the force of gravity.

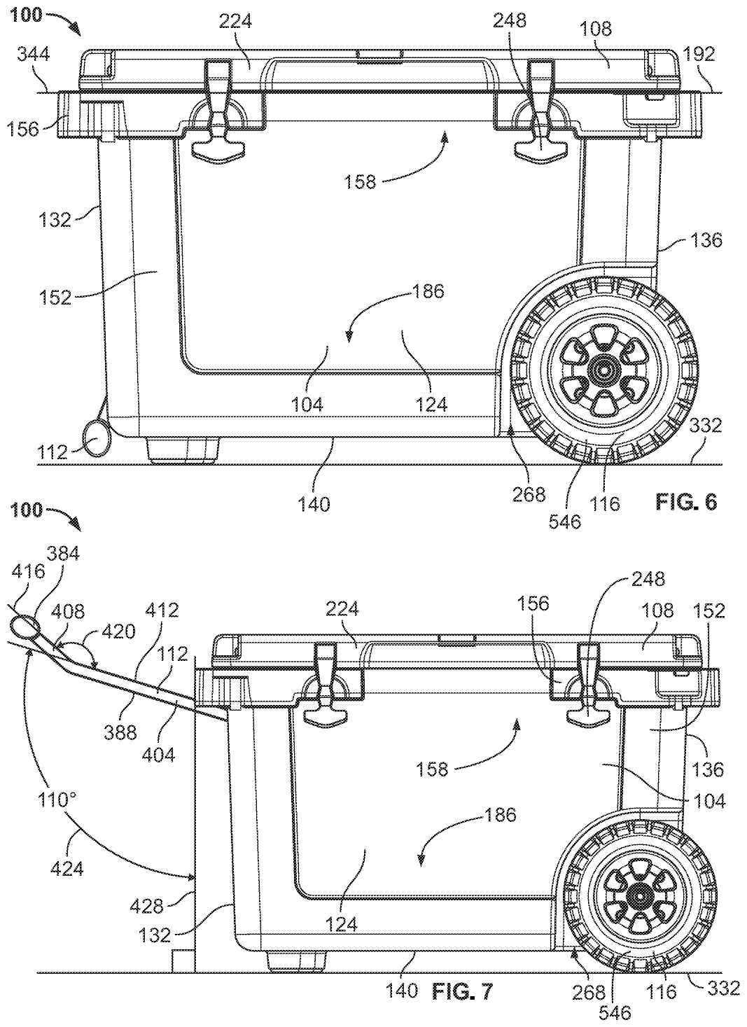

FIG. 6 illustrates the handle 112 being positioned in a lowered configuration in FIG. 6 and FIG. 7 illustrates the handle 112 being positioned in the raised configuration. Referring to FIG. 8, the handle 112 includes a set of shafts 388 that are connected to one another by a set of cross beams 392 and a handlebar 396. In the illustrated embodiment, the set of cross beams 392 and the shafts 388 are formed of tubular aluminum having a squared or rectangular cross-sectional shape. Further, the handlebar 396 is formed of a tubular aluminum having a cylindrical, elliptical, or rounded cross-sectional shape. The handle 112 may be treated with a powder coating for durability and resistance, as well as aesthetic properties. In the illustrated embodiment, the components of the handle 112 are welded (ultrasonic welding, RF welding, laser welding) together. It is contemplated that the handle 112 may be made of other materials and in other configurations. As shown in FIG. 8, the handle 112 may have silicone grips 400, such that the handle 112 is more comfortable for a user to lift and pull the container 100.

Referring to FIG. 7, each shaft 388 includes an inner shaft section 404 and an outer shaft section 408. The inner shaft section 404 defines an inner shaft section plane 412 and the outer shaft section 408 defines an outer shaft section plane 416. The inner shaft section 404 is configured to attach to the base 104 and the outer shaft section 408 terminates at the handlebar 396. The inner and outer sections 404, 408, are adjoined at approximately a third of the distance from the handlebar 396 to the rim 156 when the handle 112 is in raised configuration. In the illustrated embodiment, the inner and outer sections 404, 408 are welded together. In some embodiments, the inner and outer sections 404, 408 may be formed together as a unitary component. The inner and outer sections 404, 408 are offset at a shaft angle 420 that is defined by the inner shaft section plane 412 relative to the outer shaft section plane 416. In the illustrated embodiment, the shaft angle 420 is about 156 degrees. By joining the inner and outer shaft sections 404, 408 at a shaft angle 420 smaller than about 180 degrees, the inner shaft section 404 of the handle 112 is able to nest within a contour or recess of the left side wall 132 so as to reside within the profile of the base 104 of the container 100. With the handle 112 nesting within the contour or recess formed in the left side wall 132 and within the profile of the base 104, the envelope of the container 100 is reduced, which reduces the space needed for storage of the container 100. Additionally, the shaft angle 420 allows for the handle 112 to be configured such that the handlebar 396 extends a larger distance from the ground plane 332, i.e., a farther distance from the ground, than if the shaft angle 420 were 180 degrees, i.e, no offset. Due to the handlebar 384 being disposed farther from the ground plane 332 as a result of the shaft angle 420, a user can move the container 100 without the need to lean or bend down much, if at all, thereby promoting ergonomic transportation.

In some embodiments, the shaft angle 420 is smaller than about 175 degrees, or smaller than about 170 degrees, or smaller than about 165 degrees, or smaller than about 160 degrees, or smaller than about 155 degrees, or smaller than about 150 degrees. It is contemplated that the shaft angle 420 may be adjustable to suit users of varying heights, such as with a hinge (not shown) allowing the handlebar 384 to pivot among various positions. In some embodiments when the handle 112 is in a raised configuration, as shown in FIG. 7, the handle 112 contacts the base 104 at two or more locations in addition to being affixed to the handle hinge 216. For example, the handle 112 can contact the outer wall 152 at two loading points arranged just below the rim 156 and, due to the angle (see FIG. 7) at which the handle 112 is disposed when fully raised, the handle 112 may also contact the rim 156 at two loading points along the underside of the integrated lift slot 196. In this way, the handle 112 distributes the loading forces, e.g., the weight of the cooler 100 and the contents carried therein, to the base 104 among four loading points to effectively reduce the pressure applied to the handle 112 and the base 104 by increasing the surface area over which the forces are experienced, thereby reducing stress concentrations at each loading point on the base 104 and further reducing stress concentrations on the handle 112 itself. In some embodiments, when the handle 112 is in a raised position, the handle 112 may contact the base 104 at greater or fewer loading points. Further, the loading points may be spaced from one another, as in the illustrated embodiment with the loading points on the underside of the integrated lift slot 196 being spaced outwardly of the loading points on the outer wall 152 below the rim 156, although other configurations are possible.

It is further contemplated that the handle 112 can be telescopic, such that the handlebar 384 can be adjusted among a plurality of distances from the rim 156. For instance, each shaft 388 may include concentric tubular members that slide axially relative to one another and can be adjusted using a spring-loaded push button (not shown) that can be selectively engaged within an array of holes (not shown) to provide the handlebar 384 with telescopic adjustability. Accordingly, a user can adjust the handle 112 to a maximum extended position in which the handlebar 384 is spaced a maximum distance from the rim 156, such that the container 100 can be propped up on a ground surface at a height that facilitates drainage of the contents therein through the drain assembly 176.

Still referring to FIG. 7, the inner shaft section plane 404 forms a handle angle 424 relative to a vertical plane 428 that is tangential to and parallel with the rim 156 of the left side wall 132 and is perpendicular with the ground plane 332. In the illustrated embodiment, the handle angle 424 is about 110 degrees. By the container 100 having a handle angle 424 that is greater than about 90 degrees, the handlebar 396 extends further from the ground plane 332 and enables a user to exhibit less force to move the container 100 which provides an enhanced user experience. In some embodiments, the handle angle 424 may be greater than about 95 degrees, or greater than about 100 degrees, or greater than about 105 degrees, or greater than about 110 degrees, or greater than about 115 degrees or greater than about 120 degrees or greater than about 125 degrees or greater than about 130 degrees or greater than about 135 degrees or greater than about 140 degrees or greater than about 145 degrees or greater than about 150 degrees or greater than about 155 degrees or greater than about 160 degrees or greater than about 165 degrees or greater than about 170 degrees or greater than about 175 degrees or greater than about 180 degrees.

Now referring to FIG. 9, an enlarged view of the handle 112 and handle hinge 216 shown in FIG. 8 is illustrated. As shown, the two shafts 388 terminate separately into two tubular components 432 with apertures that are configured such that the handle hinge 216 can extend through the tubular components 432. In some embodiments, the handle 112 is configured such that the tubular components 432 rotate about the handle hinge 216. In some embodiments, the tubular components 432 are fixed to the handle hinge 216 such that the handle hinge 216 and the tubular components 432 both rotate when the handle 112 moves. A dampener 436 is in communication with and mounted above each tubular component 432. In the illustrated embodiment, the dampener 436 is two U-shaped components that may be made of silicone or another rubber like material or elastomer. In some embodiments there may be fewer or more than two U-shaped components that include two silicone pads affixed the structure of the U-shaped component that may be a different material than the two silicone pads. In the illustrated embodiment, each dampener 436 is mounted within the rim 156 such that it is in a compressed state between one of the tubular components 432 and the rim 156.

Due to the mounting configuration of the dampener 436 between the rim 156 and the tubular component 432, the dampener 436 slows the rate or speed of movement of the handle 112 by exerting a friction force on the tubular component 432. In this way, when a user lets go of the handle 112 in the raised configuration (see FIG. 7), the handle 112 can rotate to the lowered configuration by the force of gravity while the dampener 436 attenuates the rotational movement to prevent the handle 112 from slamming or impacting the base 104 in a way that causes undesirable noise or damage. The dampener 436 can be configured to exert the friction force bi-directionally, so as to regulate movement of the handle 112 in both opening and closing directions. In some embodiments, the dampener 436 is configured to exert the friction force in a single direction, such as in the direction of closing but not in the direction of opening. In some embodiments, one dampener 436 is provided. In some embodiments, a plurality of dampeners 436 are provided, such as, e.g., three, four, five, six, or seven dampeners. It is contemplated that the dampener 436 may be arranged to be in communication with the handle hinge 216 or another part of the handle 112 in addition to the tubular components 432, such as the shafts 388. In some embodiments, the dampener 436 is adjustable and configured to be adjusted among a plurality of settings corresponding to faster or slower rates of rotation.

Still referring to FIG. 9, the dampener 436 may be provided as a spring, e.g., a coil spring, a torsion spring, a helical compression spring, a leaf spring, a disc spring, a belleville spring, or any other type of spring, that attaches to the handle 112 and the base 104 and is in a first state when the handle 112 is in a fully raised position. When the handle 112 is moved in a fully lowered position such that is recessed within the envelope of the base 104, the spring is engaged and put in tension therefore slowing the handle 112 as it closes. Once the handle 112 is in a fully lowered position, the spring is in a second state such that it is in tension, but does not exert enough force on the handle 112 to move the handle 112 out of the fully lowered position. In some instances, the container 100 may have additional structure blocking the spring from moving the handle 112 when the handle 112 is in a fully lowered position. Further, the spring may act assist the user in raising the handle 112 when in retreats back to a first state after being the handle 112 is an up position. In some embodiments, the first spring state is in tension, but a reduced tension level when compared to the second state, or vice versa. In some embodiments, the spring may be mounted such that it is in compression when in the first state and an even greater compression level in a second state, or vice versa. In some embodiments, the spring may be mounted such that a first state is in compression and a second state is in compression, or vice versa.

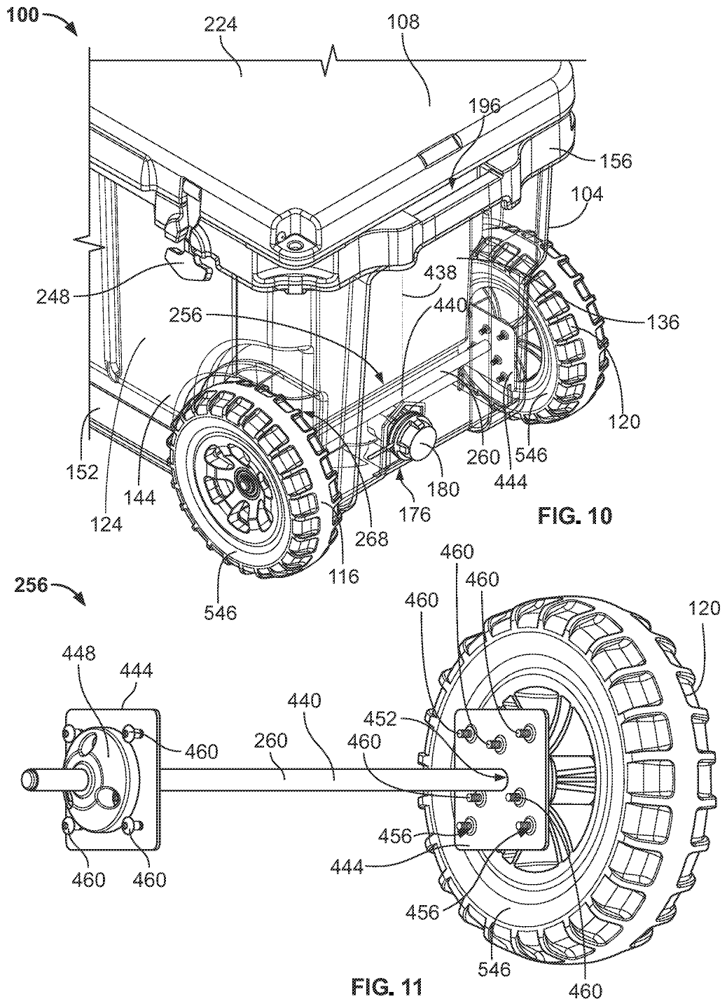

Now referring to FIG. 10, the base outer wall 152 is shown as being transparent for illustrating the suspension system 256 in conjunction with the first and the second wheels 116, 120 that are coupled to the container 100. The suspension system 256 and the wheels 116, 120 are symmetrical about a plane 438 that extends vertically through an axle mid-point 440. As shown in FIG. 10, the axle 260 extends between the base outer wall 152 and the base inner wall 144 and through the base internal insulation layer 148. The first wheel 116 is positioned in the front wheel well 268 and the second wheel 120 is positioned in the rear wheel well 272. The wheel wells 268, 272 allow the wheels 116, 120 to be mounted partially within the profile of the base 104, such that the wheels 116, 120 are partially recessed inwardly toward one another relative to the envelope of the outer wall 152.

Now referring to FIG. 11, the suspension system 256 is shown with only the second wheel 120 attached. As shown, each side of the suspension system 256 includes an internal support structure in the form of an inner plate 444 and an outer support 448. The inner plate 444 has an inner plate central aperture 452 configured to allow the axle 260 to extend through the inner plate 444. The inner plate 444 also has a plurality of threaded apertures 456 that are spaced radially about the central aperture 452 and configured such that a plurality of screws 460 can be used to mount the plate 444 to the outer wall 152 and the outer support 448 to the plate 444. At least one of the threaded apertures 456 of the inner plate 444 receives a screw 460 for attaching to the outer support 448.

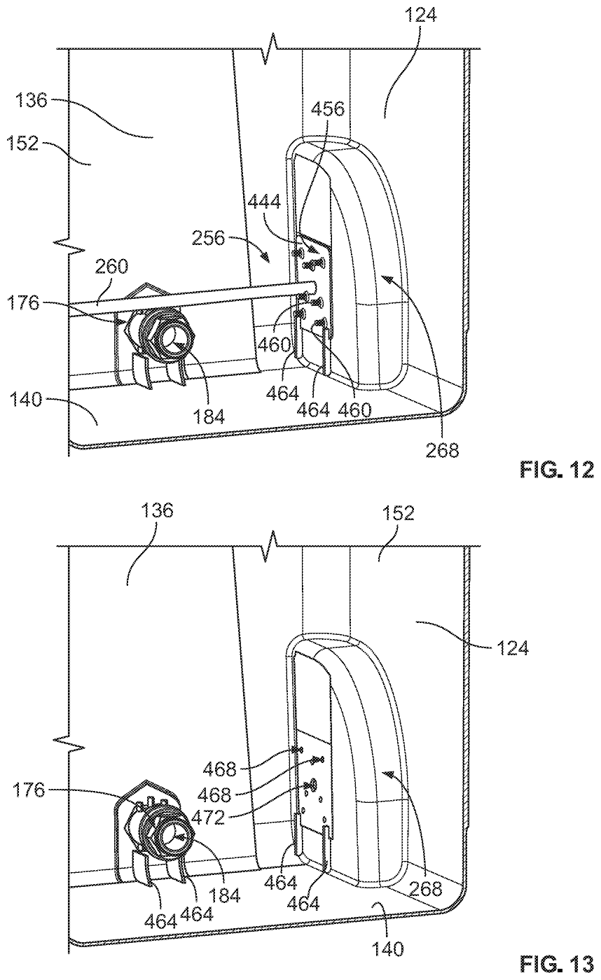

Referring now to FIG. 12, the inner plate 444 is mounted to the inner side of the base outer wall 152 along the front wheel well 268. As shown, the inner plate 444 rests on a plurality of suspension support walls 464. In the present embodiment, the suspension support walls 464 are integral with the base inner wall 144. In some embodiments, the suspension support walls 464 and the base inner walls 144 are separate components which are coupled together. The suspension support walls 464 are configured to transfer the reactionary force of the axle 260 from the weight of the container 100 from the inner plate 444 to the base bottom 144 of the container 100. Since the suspension support walls 464 at least partially transfer the reactionary force from the inner plate 444 to the base bottom 144, there is a reduced amount of force from the axle 260 exerted on the plurality of wheel well apertures that include the wheel well mounting apertures 468 and the wheel well axle apertures 472 (shown in FIGS. 13 and 15). The wheel well mounting apertures 468 are configured such that the screws 460 used to connect inserted through the mounting apertures 468 to affix the outer support 448 and the inner plate 444 to the base outer wall 152. In the illustrated embodiment, some of the mounting apertures 472 have a reinforcing rim 476. The reinforcing rims 476 of the mounting apertures 468 are configured to reinforce the opening in the base outer wall 152 to prevent base outer wall 152 from cracking especially in instances where the outer wall 152 is made from a brittle injection molded plastic or other similar material. In some embodiments, the mounting apertures 468 may not have reinforcing rims 476.

Now referring to FIGS. 14 and 15, an outer view of the front wheel well 268 is shown. In FIG. 14 the suspension system 256 is shown with the ball bearings 264 attached to the axle 260. As shown, a ball bearing restrainer 480 that is a ring-like clip is provided on the axle 260 to prevent the ball bearings 264 from disengaging with the axle 260. The ball bearing restrainer 480 is positioned within a ball bearing restrainer groove 484 that is formed on each opposing edge of the axle 260, such that the ball bearing restrainer 484 is secured to the axle 260 to prevent the ball bearings 264 and the wheels 116, 120 from disengaging from the axle 260 and the suspension system. In some embodiments, the suspension system 256 includes one ball bearing 264 in association with the first wheel 116 and one ball bearing 264 in association with the second wheel 120. In some embodiments, the suspension system 256 includes two ball bearings 264 in association with the first wheel 116 and two ball bearing 264 in association with the second wheel 120. In some embodiments, the suspension system 256 includes three or more ball bearings 264 in association with the first wheel 116 and three or more ball bearings 264 in association with the second wheel 120. In some embodiments, the suspension system 256 does not include any ball bearings 264. For example, the suspension system 256 may have lubricant on the axle 260 to minimize the friction between the and the first and second wheels 116, 120 and the axle 260 such that the container 100 rolls smoothly when pulled by a user.

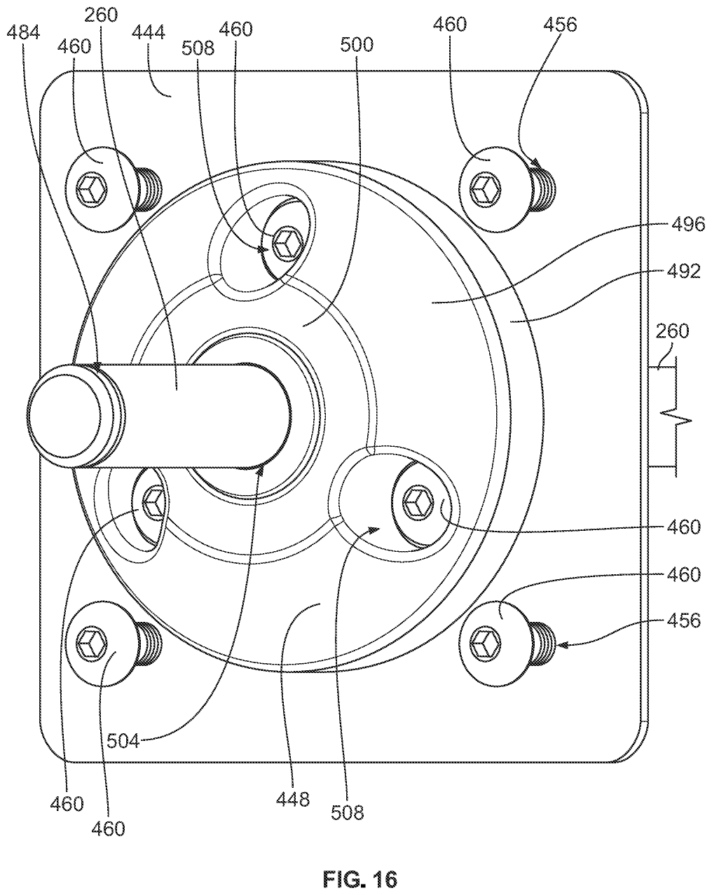

Referring to FIG. 16, the outer support 448 has a cylindrical wall 492 that extends outwardly from the base outer wall 152 (Shown in FIG. 15) and an angled surface 496 that extends inwardly toward a second flat surface 500 to form a frustoconical shape. In some embodiments, the outer support 448 may not be a cylindrical and frustoconical shape as illustrated but rather a triangular, a rectangular, a pentagonal, or hexagonal shape. The first flat surface 500 has an outer support axle aperture 504 that is configured to receive the axle 260. In the illustrated embodiment, the outer support 448 has a plurality of outer support mounting apertures 508 that are configured to receive the screws 460 for securing the outer support 448 to the base outer wall 152 and the inner plate 444. In the illustrated embodiment, the outer support 448 has three mounting apertures 508 are radially spaced around the axle aperture 504. In some embodiments, the outer support may have more than three or less than three mounting apertures 508. In some embodiments, the mounting apertures 508 may not be radially spaced apart. In some embodiments, the outer support apertures 508 are configured to receive rivets. In some embodiments, the outer support 448 may not have apertures 508. For example, the other support 448 may be mounted to the base outer wall 152 by utilizing interference fit, interlocking structures, adhesives or glues, fusion or welding, magnetic elements, or any other suitable attachment methods.

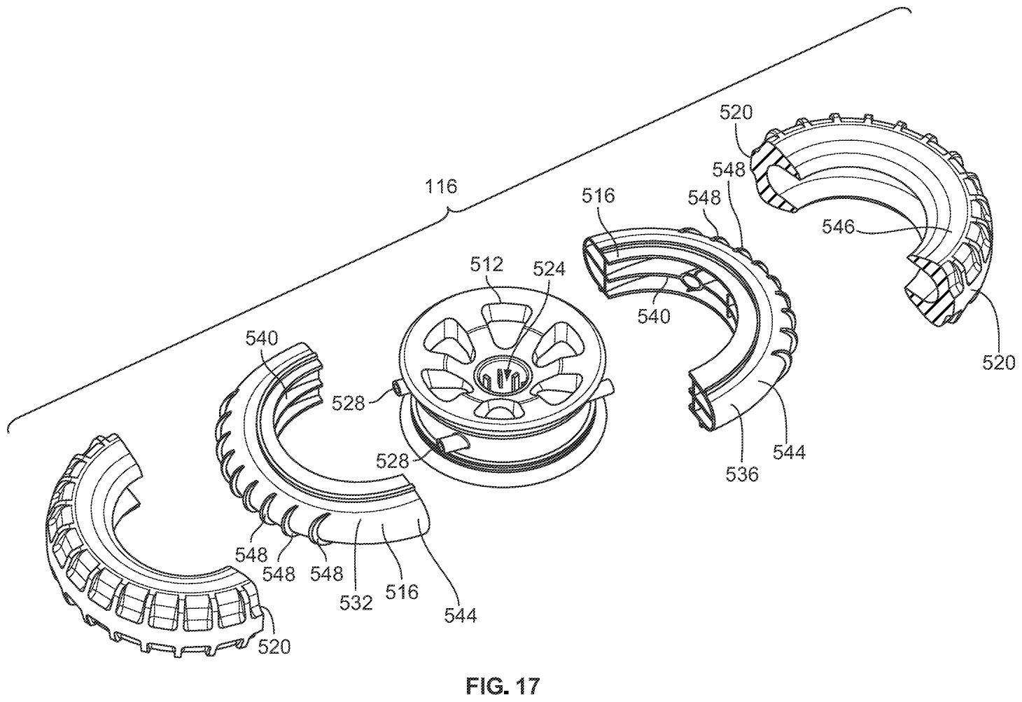

Now referring to FIG. 17, first wheel 116 includes a central hub 512, a tire support structure 516, and a tire 520. The central hub 512 has a cylindrical shape and a hub central aperture 524 that is configured to be rotatably coupled to the axle 260 in connection with the ball bearings 264 (shown in FIG. 14). The central hub 512 has four protruding screw receivers 528 that are configured in two pairs that protrude on opposite ends of the central hub 512. The screw receivers 528 are configured to receive the screws (not shown) used to connect the internal tire support structure 516 to the central hub 512. In some embodiments, the internal tire support structure 516 is fastened or secured together without screws and, instead, utilizes interference fit, interlocking structures, adhesives or glues, rivets, fusion or welding, magnetic elements, or any other suitable attachment methods.

The internal tire support structure 516 includes a first internal support structure half 532 and a second internal tire support structure half 536 that are interchangeable and independently attached to the central hub 512. For example, the first internal tire support structure half 532 is configured to be attached on either side of the central hub 512 and the second internal tire support structure half 536 is configured to be attached to either side of the central hub 512. Thus, the first and the second tire support structure halves 532, 536 are interchangeable and independently attached the central hub 512. In some embodiments, the first and the second internal tire support structure halves 532, 536 are different from one each other such that they are unique and configured to attach to the central hub 512 in only one position making them not interchangeable.

Each internal tire support structure half 532, 536 includes internal support walls 540 to support an outer rounded surface 544. As illustrated, there is one internal support wall 540 that is configured to extend perpendicularly to the hub central aperture 524, and there are three internal support walls 540 that extend parallel with the hub central aperture. 524. In some embodiments, there may be two or more internal support walls 540 that extend perpendicularly with the hub central aperture. In some embodiments there may be four or more internal support walls 540 arranged in parallel with the hub central aperture 524. In some embodiments there may greater or fewer internal support walls 540 that extend parallelly with the hub central aperture 524. In some embodiments, there may only be internal support walls 540 arranged in parallel with the central hub aperture 524. Further, in some embodiments, there may only be internal walls 540 that extend perpendicularly with the central hub aperture 524. In some embodiments, the internal support walls may extend at an offset angle that is neither perpendicular nor parallel to the central hub aperture 524. In some embodiments, there may be no internal support walls 540, such that the internal support structure is hollow. In some embodiments, the internal support walls 540 may be substituted with an internal lattice structure (not shown) or an array of beams that are configured to support the outer rounded surface 544. The outer rounded surface 544 is configured to be in contact with the tire 520. The tire 520 may be made of polyurethane and may have screen printing (not shown) on a tire sidewall 546.

Still referring to FIG. 17, the outer rounded surface 544 of each internal tire support structure half 532, 536 has a plurality of protruding walls 548. The plurality of protruding walls 548 are configured to provide a frictional force between the first and second internal support structure 532, 536 and the tire 520 such that when the tire 520 rotates, the entire wheel 116 rotates. In some embodiments, the protruding walls 548 may be substituted with protruding ridges or bumps (not shown). Additionally, the first and second internal support structure halves 532, 536 are configured to support the tire 520 without the need for the tire 520 to be solid polyurethane which would increase the weight of the container 100. Accordingly, the first and second wheels, 116, 120 can have enlarged tread for traversing various natural or man-made terrains, e.g., sand, forest or woodland trails, rock formations, stairs, decks, gravel, pavement, or the like, while reducing the overall weight of the container 100. By incorporating the first and second internal support structure halves 532, 536, the tires 520 of the first and second wheels 116, 120 are configured to be resistant to punctures and impacts, since there are no inflated inner tubes under pressure.

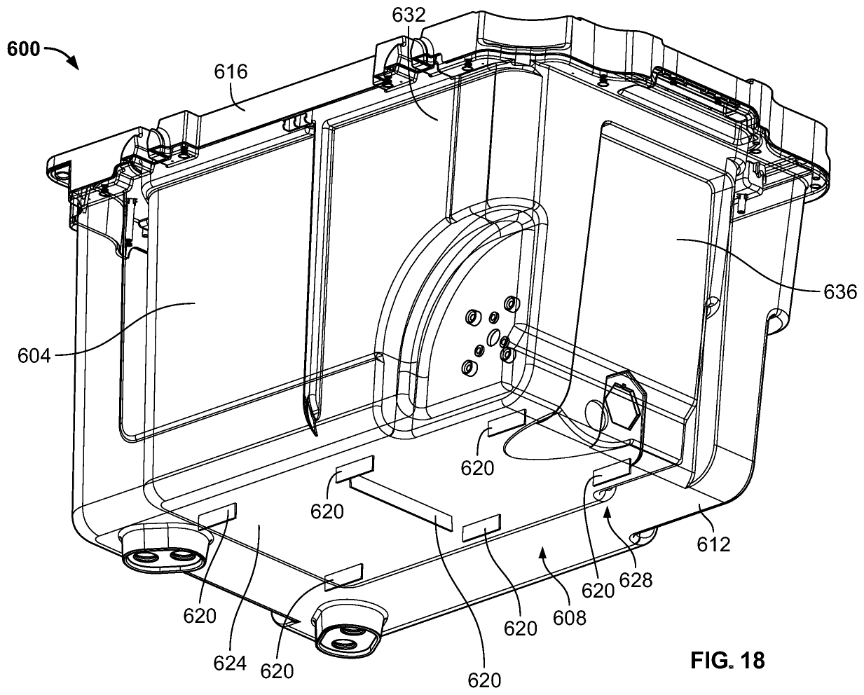

Now referring to FIG. 18, another embodiment of a container base 600 is shown. The container base 600 is similar in both structure and function to the base 104 of FIGS. 1-17. The container base 600 has an inner wall 604, an internal insulation layer 608, and an outer wall 612. Further, the base has a rim 616. The base 600 is different from the base 104 of FIGS. 1-17 since there are a plurality of injection spacer walls 620 mounted on a bottom surface 624 of the inner wall 604. The injection spacer walls 620 extend from the bottom surface into a void 628 between the inner and outer walls 604, 612. The injection spacer walls 620 are configured such that they facilitate the dispersion of the injected insulative material that forms the internal insulation layer 608. In the illustrated embodiment of FIG. 18, there are seven injection spacer walls 620. Six of the injection spacer walls 620 are positioned to extend parallel with a front wall 632 and rear wall (not shown) of the base 600. The seventh wall extends perpendicularly to the front wall 632 and is positioned halfway between a right wall 636 and a left wall (not shown). In some embodiments, the injection spacer walls 620 could be arranged in a lid (not shown), such as the lid 108 of the container 100 of FIGS. 1-17. In some embodiments the spacer walls 620 are configured to be load-bearing and provide structural support between the inner and outer walls 604, 612. In some embodiments, the spacer walls 620 are not configured to be load-bearing, such as in instances where the internal insulative layer 608 is configured to provide structural support between the inner and the outer walls 604, 612.

Although various aspects are herein disclosed in the context of certain preferred embodiments, implementations, and examples, it will be understood by those skilled in the art that the present invention extends beyond the specifically disclosed embodiments to other alternative embodiments and/or uses of the inventive aspects and obvious modifications and equivalents thereof. In addition, while a number of variations of the aspects have been noted, other modifications, which are within their scope, will be readily apparent to those of skill in the art based upon this disclosure. It should be also understood that the scope of this disclosure includes the various combinations or sub-combinations of the specific features and aspects of the embodiments disclosed herein, such that the various features, modes of implementation and operation, and aspects of the disclosed subject matter may be combined with or substituted for one another. Thus, it is intended that the scope of the present invention herein disclosed should not be limited by the particular disclosed embodiments or implementations described above, but should be determined only by a fair reading of the claims.

Similarly, this method of disclosure, is not to be interpreted as reflecting an intention that any claim require more features than are expressly recited in that claim. Rather, as the following claims reflect, inventive aspects lie in a combination of fewer than all features of any single foregoing disclosed embodiment. Thus, the claims following the Detailed Description are hereby expressly incorporated into this Detailed Description, with each claim standing on its own as a separate embodiment.

### INDUSTRIAL APPLICABILITY

Numerous modifications to the present invention will be apparent to those skilled in the art in view of the foregoing description. Accordingly, this description is to be construed as illustrative only and is presented for the purpose of enabling those skilled in the art to make and use the invention. The exclusive rights to all modifications which come within the scope of the appended claims are reserved.

We claim:

1. A container, comprising:
a base including an outer wall, an internal insulation layer, and an inner wall;
a movable lid connected to the base;
a handle connected to the base;
a first wheel and a second wheel that are connected by an axle extending through the base; and
a suspension system,
wherein the suspension system is connected to the outer wall and includes at least one ball bearing in association with the first wheel and the second wheel.

2. The container of claim 1, wherein the axle extends through an outer support structure and an inner support structure of the suspension system.

3. The container of claim 2, wherein the inner support structure is a plate with a central aperture that is configured to allow the axle to extend through the plate.

4. The container of claim 3, wherein the plate has a plurality of threaded apertures that are spaced radially about the central aperture and configured such that a plurality of screws can be used to mount the plate to the outer wall and the outer support structure to the plate.

5. The container of claim 3, wherein the outer wall has one or more support walls configured to support the plate on an inner side of the outer wall of a wheel well.

6. The container of claim 2, wherein the outer support structure has a cylindrical wall and an angled surface that extends inwardly toward a first flat surface that has a central aperture configured to receive the axle.

7. The container of claim 1, wherein the lid has a bottom surface facing an internal volume of the container, and the bottom surface of the lid has rectangular protrusion with a cargo net attached therefrom.

8. The container of claim 1, wherein the lid is moveably connected to the base using a hinge.

9. The container of claim 1, wherein the inner wall and the outer wall are made of injection molded plastic.

10. A container, comprising:
a base including an outer wall, an internal insulation layer, and an inner wall;
a movable lid connected to the base;
a handle connected to the base; and
a first and a second wheel connected to the base through an axle and a suspension system,
wherein the first and a second wheel include a central hub, an internal tire support structure, and a tire.

11. The container of claim 10, wherein the central hub has one or more protruding screw receivers configured to connect the central hub to the internal tire support structure.

12. The container of claim 10, wherein the internal tire support structure comprises first and second internal tire support structure halves that are interchangeable and independently attached to the central hub.

13. The container of claim 10, wherein the internal tire support structure includes one or more protruding walls from an outer rounded surface.

14. The container of claim 10, wherein each wheel uses one or more ball bearings that are restrained on the axle by a ring like clip in a groove on the axle.

15. The container of claim 10, wherein the inner wall has a plurality of injection spacer walls that extend from a bottom surface of the inner wall that are configured to facilitate dispersion of insulation when manufacturing the internal insulation layer.

16. The container of claim 15, wherein the plurality of injection spacer walls has at least one guide wall that extends from a right side to a left side and at least one injection spacer wall that extends from a front side to a rear side.

17. A container, comprising:
a base including an outer wall, an internal insulation layer, and an inner wall;
a movable lid connected to the base;
a handle connected to the base; and
a handle release system that is configured to apply friction on the handle when moved in at least one direction.

18. The handle release system of claim 17, wherein the system comprises at least one dampener.

19. The container of claim 18, wherein the dampener comprises silicone.

20. The container of claim 17, wherein, when the handle is in an open position, a handle angle is defined between a handle support beam and a vertical plane that is perpendicular to a ground plane, wherein the handle angle is between about 100 degrees and about 120 degrees.

21. The container of claim 17, wherein the lid has a rectangular protrusion that extends from a bottom surface of the lid, the rectangular protrusion at least partially defines a storage space with the bottom surface of the lid and a cargo net that is attached to the rectangular protrusion.

22. The container of claim 21, wherein the cargo net comprises silicone.
